(19) United States
(12) Patent Application Publication
(10) Pub. No.: US 2024/0035561 A1
(43) Pub. Date: Feb. 1, 2024

(54) SHIFT DEVICE

(71) Applicant: KABUSHIKI KAISHA TOKAI-RIKA-DENKI-SEISAKUSHO, Aichi (JP)

(72) Inventor: Shigeki YOSHIDA, Aichi (JP)

(21) Appl. No.: 18/038,644

(22) PCT Filed: Oct. 22, 2021
(86) PCT No.: PCT/JP2021/039165

§ 371 Date: May 24, 2023

(30) Foreign Application Priority Data
Nov. 27, 2020 (JP) 2020-197526

(51) Int. Cl. F16H 59/10

(52) U.S. Cl. CPC F16H 59/105

(57) ABSTRACT

In this shift device, a worm, a detent gear, and a rotation shaft (including a detent pin) of a lever are rotated by a motor being driven, causing the lever to pivot. At all shift positions of the lever, the detent pin urges the detent gear toward a side of a meshed position between the detent gear and the worm. This enables rattling between the detent gear and the worm to be suppressed at all shift positions of the lever.

### TECHNICAL FIELD

The present invention relates to a shift device in which a shift body is moved and a shift position of the shift body is changed.

### BACKGROUND ART

In an operation device described in Japanese Patent Application Laid-Open (JP-A) No. 2015-72718, an operation knob is moved, and a shift position of the operation knob is changed to a P position, an R position, an N position, or a D position. An actuator gear is provided to a latch means, the latch means urges the actuator gear, and the operation knob is biased toward a shift position side. Furthermore, the actuator gear and a worm gear of the actuator are coupled together, and the actuator moves the operation knob though the latch means.

However, when the operation knob is positioned in the P position in this operation device, the latch means urges the actuator gear toward the opposite side to the connecting position between the actuator gear and the worm gear.

### SUMMARY OF INVENTION

### Technical Problem

In consideration of the above circumstances, an object of the present invention is to obtain a shift device capable of suppressing rattling between a connecting member and a moving mechanism at all shift positions of a shift body.

### Solution to Problem

A shift device according to a first aspect of the present invention includes a shift body that is movable to change a shift position, an urging mechanism provided with a connecting member, the urging mechanism being configured to urge the connecting member such that the shift body is urged toward a shift position side, and a moving mechanism connected to the connecting member, the moving mechanism being configured to move the shift body via the urging mechanism, with the urging mechanism urging the connecting member toward a side of a connecting position between the moving mechanism and the connecting member at all shift positions of the shift body.

A shift device according to a second aspect of the present invention is the shift device according to the first aspect of the present invention, wherein the urging mechanism urges the connecting member toward a connecting position between the connecting member and the moving mechanism at a center position of all shift positions of the shift body.

A shift device according to a third aspect of the present invention is the shift device according to the first aspect or the second aspect of the present invention, wherein a lower side of the connecting member is connected to the moving mechanism.

A shift device according to a fourth aspect of the present invention is the shift device according to any one of the first aspect to the third aspect of the present invention, wherein the urging mechanism urges the connecting member at a single location.

A shift device according to a fifth aspect of the present invention is the shift device according to any one of the first aspect to the fourth aspect of the present invention, wherein the shift body is rotatable and the connecting member is disposed on a rotation shaft of the shift body.

In the shift device according to the first aspect of the present invention, the shift body is moved and the shift position of the shift body is changed. Moreover, the connecting member is provided to the urging mechanism, and the urging mechanism urges the connecting member such that the shift body is urged toward the shift position side. Furthermore, the connecting member and the moving mechanism are connected together, and the moving mechanism moves the shift body through the urging mechanism.

The urging mechanism urges the connecting member toward the side of the connecting position between the moving mechanism and the connecting member at all shift positions of the shift body. This means that rattling between the connecting member and the moving mechanism at all the shift positions of the shift body can be suppressed.

In the shift device according to the second aspect of the present invention, at the center position of all the shift positions of the shift body, the urging mechanism urges the connecting member toward the connecting position between the connecting member and the moving mechanism. This thereby enables urging force of the urging mechanism on the connecting member toward the side of the connecting position between the connecting member and the moving mechanism to be suppressed from decreasing at an end side shift position of the shift body.

In the shift device according to the third aspect of the present invention, a lower side of the connecting member is connected to the moving mechanism. The weight of the connecting member itself accordingly acts at the connecting position between the connecting member and the moving mechanism, enabling rattling between the connecting member and the moving mechanism to be suppressed further.

In the shift device according to the fourth aspect of the present invention, the urging mechanism urges the connecting member at a single location. This enables a simple configuration of the urging mechanism.

In the shift device according to the fifth aspect of the present invention, the shift body is able to rotate.

The connecting member is disposed on the rotation shaft of the shift body. This thereby enables rattling of the shift body with respect to the connecting member to be suppressed.

### BRIEF DESCRIPTION OF DRAWINGS

FIG. 1 is a perspective view illustrating a shift device according to a first exemplary embodiment of the present invention, as viewed obliquely from the left front.

FIG. 2 is an exploded perspective view of a shift device according to the first exemplary embodiment of the present invention, as viewed obliquely from the left front.

FIG. 3A is a side view as viewed from the left illustrating when a lever in a shift device according to the first exemplary embodiment of the present invention is positioned in an “N” position.

FIG. 3B is a cross-section as viewed from the left of a detent mechanism illustrating when a lever in a shift device according to the first exemplary embodiment of the present invention is positioned in an “N” position.

FIG. 4A is a side view as viewed from the left illustrating when a lever in a shift device according to the first exemplary embodiment of the present invention has been pivoted toward the front side from an “N” position.

FIG. 4B is a cross-section as viewed from the left illustrating a detent mechanism when a lever in a shift device according to the first exemplary embodiment of the present invention has been pivoted toward the front side from an “N” position.

FIG. 5 is a cross-section as viewed from the left illustrating main portions of a shift device according to the first exemplary embodiment of the present invention.

FIG. 6 is a perspective view illustrating a shift device according to a second exemplary embodiment as viewed obliquely from the left front.

FIG. 7 is an exploded perspective view illustrating a shift device according to the second exemplary embodiment as viewed obliquely from the left front.

FIG. 8A is a side view as viewed from the left illustrating when a lever in a shift device according to the second exemplary embodiment has been positioned in the “N” position.

FIG. 8B is a cross-section as viewed from the front of a detent mechanism illustrating when a lever in a shift device according to the second exemplary embodiment has been positioned in the “N” position.

FIG. 9A is a side view as viewed from the left illustrating when a lever in a shift device according to the second exemplary embodiment has been pivoted toward the front side from an “N” position.

FIG. 9B is a cross-section as viewed from the front of a detent mechanism illustrating when a lever in a shift device according to the second exemplary embodiment has been pivoted toward the front side from an “N” position.

FIG. 10 is a cross-section as viewed from the left illustrating main portions of a shift device according to the second exemplary embodiment.

FIG. 11A is a side view illustrating a detent tube of a shift device according to the second exemplary embodiment prior to assembly.

FIG. 11B is a side view illustrating a detent tube in an assembled state of a shift device according to a second exemplary embodiment.

FIG. 12A is a side view illustrating a detent tube of a shift device according to a modified example of the second exemplary embodiment prior to assembly.

FIG. 12B is a side view illustrating a detent tube in an assembled state of a shift device according to a modified example of the second exemplary embodiment.

### DESCRIPTION OF EMBODIMENTS

### First Exemplary Embodiment

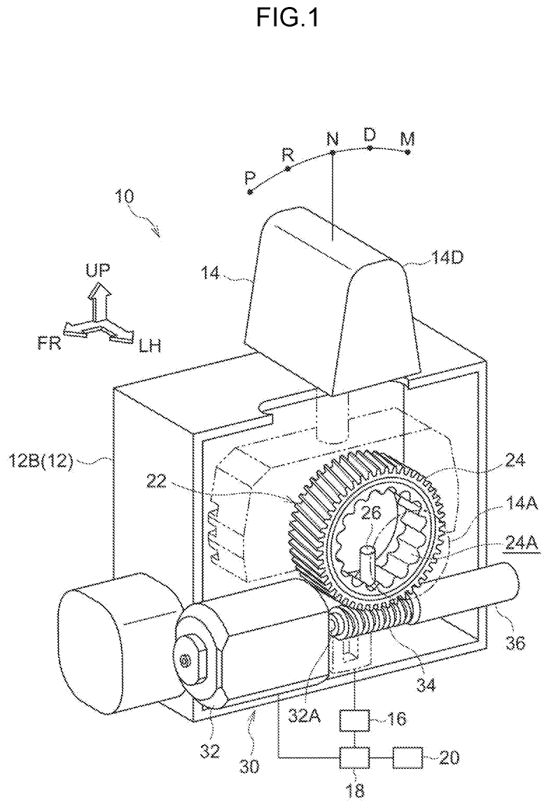

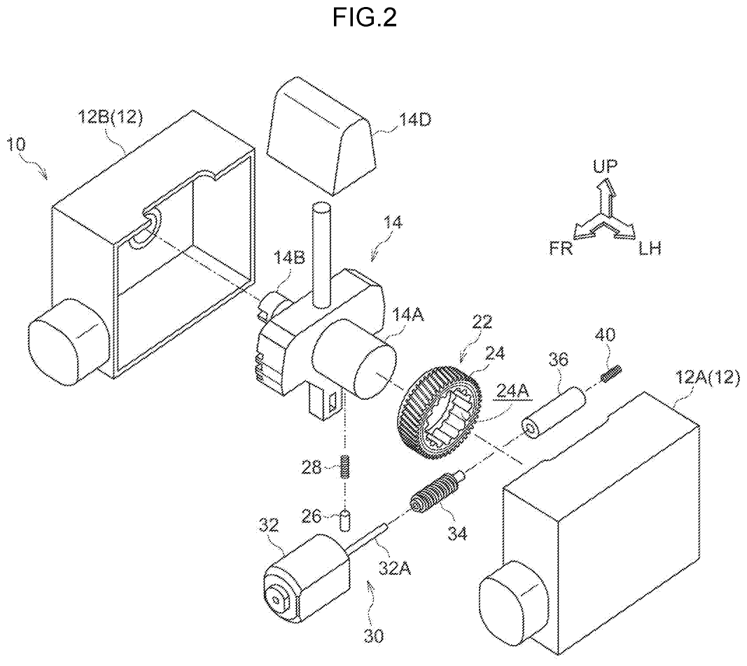

FIG. 1 illustrates a perspective view of a shift device 10 according to a first exemplary embodiment of the present invention as viewed obliquely from the left front, and FIG. 2 illustrates an exploded perspective view of the shift device 10 as viewed obliquely from the left front. Note that in the drawings arrow FR indicates a front direction of the shift device 10, arrow LH indicates a left direction of the shift device 10, and arrow UP indicates an upward direction of the shift device 10.

The shift device 10 according to the present exemplary embodiment is installed to a console of a vehicle with the front, left, and upward directions of the shift device 10 each being orientated along the front, left, and upper directions of the vehicle.

As illustrated in FIG. 1 and FIG. 2, a plate 12 having a substantially cuboidal box shape is provided to the shift device 10, with the plate 12 fixed to an inside of the console. A left plate 12A is provide at a left side of the plate 12, a right plate 12B is provided at a right side of the plate 12, and the plate 12 is configured by assembling the left plate 12A and the right plate 12B together.

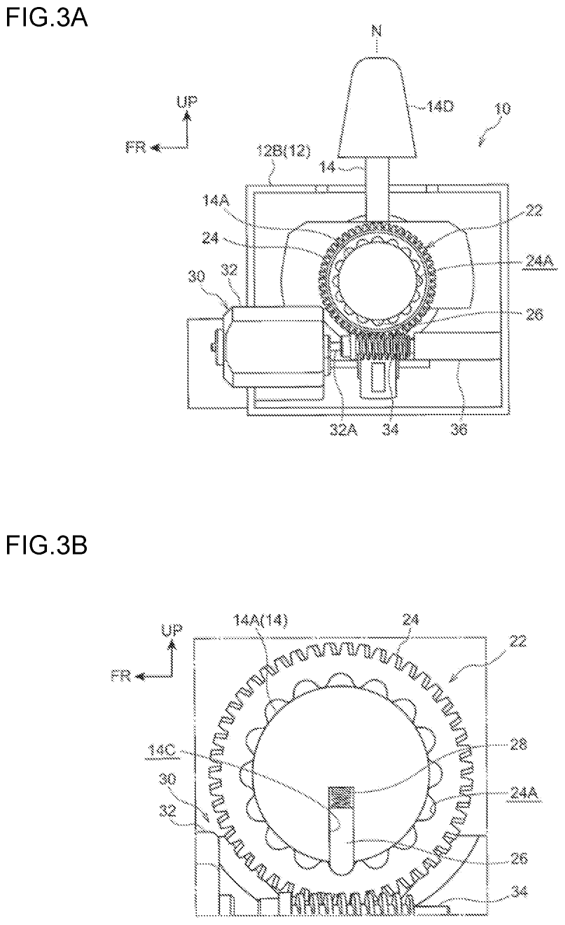

A rod shaped lever 14, serving as a shift body, is provided inside the plate 12. A rotation shaft 14A and a rotation shaft 14B each having a substantially circular pillar shape are integrally formed at a left side and a right side of middle portion of the lever 14 in an up-down direction. The rotation shaft 14A and the rotation shaft 14B each protrude toward the left or right and are disposed coaxially to each other. The rotation shaft 14A and the rotation shaft 14B are rotatably supported respectively by a left wall or a right wall of the plate 12, with the lever 14 thereby being able to pivot (move, rotate) in a front-rear direction about a center axis of the rotation shaft 14A and the rotation shaft 14B. A circular pillar shaped urging hole 14C (see FIG. 3B) is formed in the rotation shaft 14A, with the urging hole 14C extending along a radial direction of the rotation shaft 14A and being open toward a lower side.

An upper side portion of the lever 14 protrudes pivotably to an upper side of the plate 12, and protrudes pivotably to an upper side (vehicle cabin inside) of the console, with a trapezoidal pillar shaped knob 14D, serving as a grip portion, fixed to an upper end portion of the lever 14. The lever 14 is able to be pivotally-operated in a state in which an occupant (in particular, a driver) of a vehicle has gripped the knob 14D, and a shift position of the lever 14 is changed in sequence between a “P” position (parking position), an “R” position (reverse position), an “N” position (neutral position), a “D” position (drive position), and an “M” position (manual position) by the lever 14 (the knob 14D) being pivoted from the front side toward the rear side. The lever 14 is able to pivot in a range from the “P” position to the “M” position, and a pivoting angle between each of the shift positions of the lever 14 is the same (for example 22.5°).

A detection device 16 is connected to the lever 14, the detection device 16 detects a pivoting position of the lever 14 so as to detect the shift position of the lever 14. The detection device 16 is electrically connected to a control device 18 of the vehicle, and an automatic transmission mechanism 20 (gearbox) of the vehicle is electrically connected to the control device 18.

A detent mechanism 22, serving as an urging mechanism, is provided at a left side of the lever 14.

A substantially circular cylinder shaped detent gear 24, serving as a connecting member, is provided to the detent mechanism 22, with the detent gear 24 configured by a worm wheel. The rotation shaft 14A of the lever 14 passes coaxially through and fits inside of the detent gear 24, with the detent gear 24 configured so as to be able to be rotate about a center axis of the rotation shaft 14A. Axial direction movement of the detent gear 24 is restricted, and rotation of the detent gear 24 is restricted, as described later. Plural recesses 24A having a semicircular shaped in cross-section and serving as urged portions are formed to an inner circumferential surface of the detent gear 24, with the recesses 24A extending along the axial direction of the detent gear 24. The plural recesses 24A are arranged at a uniform spacing around the circumferential direction of the detent gear 24, and the arrangement spacing angle of the recesses 24A is the same as the pivoting angle between each of the shift positions of the lever 14.

A substantially circular pillar shaped detent pin 26, serving as an urging member, is provided to the detent mechanism 22. The detent pin 26 is inserted inside the urging hole 14C of the rotation shaft 14A of the lever 14 so as to be able to move, with a leading end surface (lower side surface) thereof protruding out in a spherical surface shape.

A detent spring 28 (compression coil spring) serving as a urging means is provided to the detent mechanism 22. The detent spring 28 spans between a bottom surface (upper surface) of the urging hole 14C and a base end surface (upper surface) of the detent pin 26, with the detent spring 28 urging the detent pin 26 toward the lower side.

When the lever 14 is disposed at each of the shift positions, the detent pin 26 is inserted into one of the recesses 24A of the detent gear 24 by the urging force of the detent spring 28, and fits against the recesses 24A in the circumferential direction of the detent gear 24 (see FIG. 3A and FIG. 3B). This means that the rotational position of the rotation shaft 14A is maintained, and the lever 14 is held in each of the shift positions (the lever 14 is urged toward each shift position side).

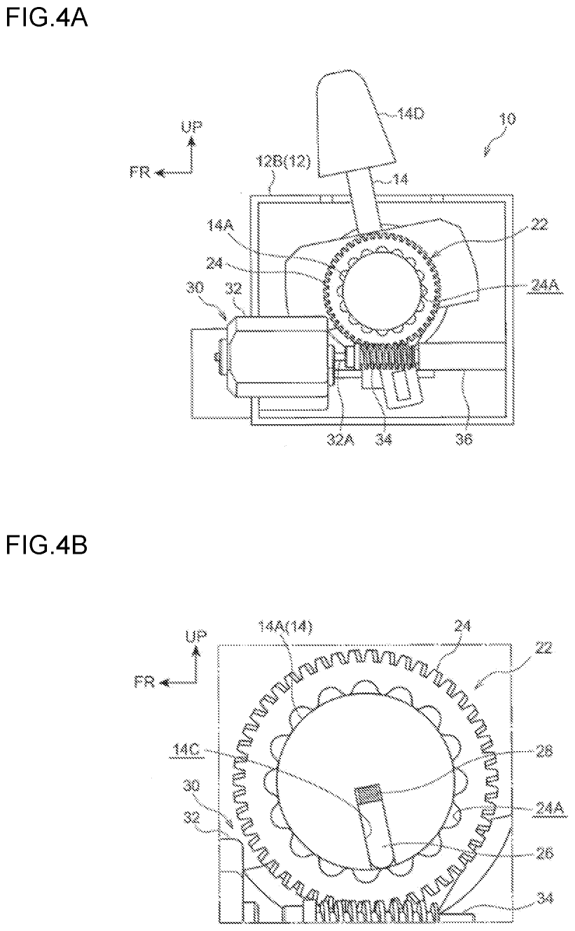

When the lever 14 is pivotally operated to change the shift position of the lever 14, the rotation shaft 14A is rotated and the detent pin 26 is pivoted (see FIG. 4A and FIG. 4B). This means that after the detent pin 26 has been moved toward the base end side thereof against the urging force of the detent spring 28 and has exited from the recess 24A, the detent pin 26 is moved toward the leading end side thereof by the urging force of the detent spring 28, and is inserted into a recess 24A adjacent to this recess 24A. This means that after a pivot resistance force has acted in the pivot-operation of the lever 14, a pivoting assist force then acts, with a ratcheting sensation acting on the pivot-operation of the lever 14.

When the lever 14 is positioned in the “N” position (a center position of all the shift positions and a center position of the pivotable range), the leading end portion of the detent pin 26 faces downward, and the detent gear 24 is urged downward (see FIG. 3A and FIG. 3B). When the lever 14 is positioned in the “P” position or the “M” position (the two end positions of all the shift positions and the two end positions of the pivotable range), the leading end portion of the detent pin 26 faces obliquely downward, and the detent gear 24 is urged obliquely downward. This means that when the lever 14 is positioned in all the shift positions and in all of the pivotable range, the leading end portion of the detent pin 26 faces toward a lower side, and the detent gear 24 is urged toward the lower side (toward a lower side with respect to a horizontal direction).

A drive mechanism 30, serving as a moving mechanism, is provided at a left side of the lever 14.

A motor 32, serving as a drive device, is provided to the drive mechanism 30, and the motor 32 is fixed to a front wall of the left plate 12A and disposed inside the plate 12. An output shaft 32A of the motor 32 extends rearward, and is restricted from moving in the front-rear direction (axial direction), with the output shaft 32A inserted coaxially inside a worm 34, serving as a connected member. The worm 34 is not able to move forward but is able to move rearward with respect to the output shaft 32A, and the worm 34 is not able to rotate relative to the output shaft 32A.

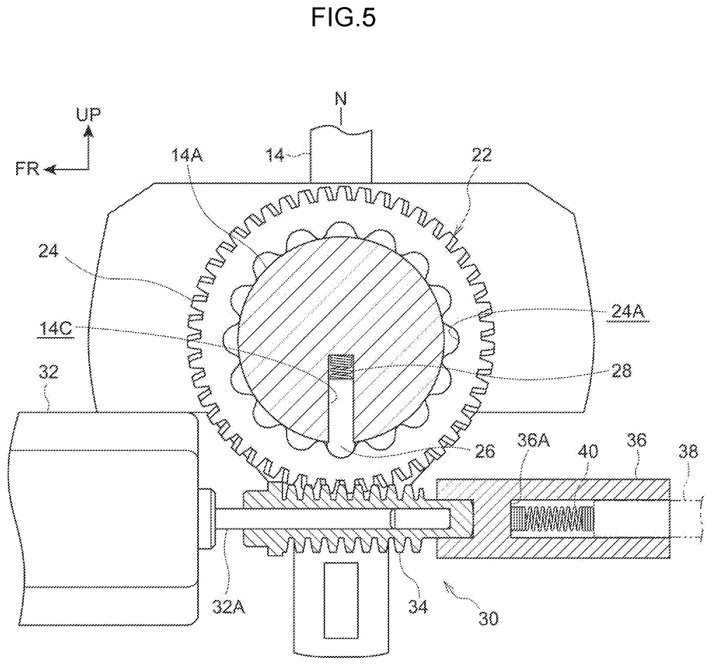

A substantially circular cylinder shaped holder 36 (see FIG. 5) is disposed at the rear side of the worm 34, with the inside of the holder 36 divided into a front section and a rear section by a circular pillar shaped holder wall 36A. A circular pillar shaped holder shaft 38 is fitted into the rear section inside the holder 36, with the holder shaft 38 extending forward from a rear wall of the left plate 12A and supporting the holder 36. A holder spring 40 (compression coil spring) spans between the holder wall 36A and the holder shaft 38, with the holder spring 40 urging the holder 36 (the holder wall 36A) forward. A rear end portion (leading end portion) of the worm 34 is fitted into the front section of the inside of the holder 36, with the holder wall 36A urging the worm 34 forward, and limiting rearward movement of the worm 34.

The worm 34 is disposed at a lower side of the detent gear 24, is meshed with (connected to) a lower end of the detent gear 24, and when the lever 14 is positioned in the “N” position, the leading end portion of the detent pin 26 faces toward the meshing position between the detent gear 24 and the worm 34. The worm 34 restricts rotation of the detent gear 24, and when the worm 34 is rotated, the detent gear 24 is also rotated.

The motor 32 is electrically connected to the control device 18, and the motor 32 is driven under control from the control device 18, with the worm 34 rotated integrally with the output shaft 32A of the motor 32. This means that the detent gear 24 is rotated, and the rotation shaft 14A of the lever 14 is rotated through the detent pin 26, such that the lever 14 is pivoted and the shift position of the lever 14 is changed.

Next, description follows regarding operation of the present exemplary embodiment.

In the shift device 10 configured as described above, the detent gear 24 of the detent mechanism 22 and the worm 34 of the drive mechanism 30 are meshed together, and the worm 34 restricts rotation of the detent gear 24.

When the lever 14 is pivotally operated to change the shift position of the lever 14, at the detent mechanism 22, after the detent pin 26 exits from the recess 24A of the detent gear 24 against the urging force of the detent spring 28, the detent pin 26 is then inserted into the recess 24A adjacent to this recess 24A by the urging force of the detent spring 28. [0039]

When the shift position of the lever 14 has been changed (when the detection device 16 has detected a change in the shift position of the lever 14), the shift range of the automatic transmission mechanism 20 is changed under control by the control device 18 to the shift range corresponding to the shift position of the lever 14.

Moreover, when for example the vehicle is driving autonomously (including parking autonomously), the shift range of the automatic transmission mechanism 20 is changed automatically under control from the control device 18. In cases in which the shift range of the automatic transmission mechanism 20 has been changed automatically, the motor 32 is driven in the drive mechanism 30 under control from the control device 18 based on the shift position of the lever 14 as detected by the detection device 16. This means that the worm 34, the detent gear 24, and the rotation shaft 14A (containing the detent pin 26) of the lever 14 are rotated to pivot the lever 14, thereby, the shift position of the lever 14 is changed and the shift position of the lever 14 corresponds to the shift range of the automatic transmission mechanism 20.

This means that the shift position of the lever 14 is changed even though the detent pin 26 does not exit from the recess 24A of the detent gear 24 against the urging force of the detent spring 28, and so a rotation load on the detent gear 24 from the motor 32 is lessened, and the time taken to change the shift position of the lever 14 is shortened. Furthermore, noise from the detent pin 26 being inserted into the recess 24A by the urging force of the detent spring 28 is limited from occurring, lessoning operation noise. Moreover, pivoting of the lever 14 becomes smooth due to the detent pin 26 not coming out from the recess 24A against the urging force of the detent spring 28 nor being inserted therein by the urging force of the detent spring 28.

When the motor 32 is driven and the lever 14 is being pivoted, the detent pin 26 comes out from the recess 24A of the detent gear 24 against the urging force of the detent spring 28 if pivoting of the lever 14 is limited, allowing the rotation shaft 14A of the lever 14 to rotate with respect to the detent gear 24. This means that damage to the detent gear 24 or the worm 34 is suppressed from occurring.

In all the shift positions of the lever 14, the detent pin 26 urges the detent gear 24 toward the side of the meshed position between the detent gear 24 and the worm 34 (lower side) by means of the detent spring 28. Therefore, in all the shift positions of the lever 14, rattling due to backlash between the detent gear 24 and the worm 34 can be suppressed, enabling rattling (rotation) of the detent gear 24 with respect to the worm 34 to be suppressed, and rattling (rotation) of the rotation shaft 14A (containing the detent pin 26) of the lever 14 can be suppressed, enabling rattling (pivoting) of the lever 14 to be suppressed. This enables the pivoting operation performance of the lever 14 to be improved, and also enables the shift range change performance of the automatic transmission mechanism 20 using the pivoting operation of the lever 14 to be improved.

Furthermore, at the center position (“N” position) of all of the shift positions of the lever 14, the detent pin 26 urges the detent gear 24 toward the meshed position between the detent gear 24 and the worm 34 (downward) by mean of the detent spring 28. This means that at the two end shift positions (“P” position and “M” position) of the lever 14, the urging force of the detent pin 26 on the detent gear 24 toward the side of the meshed position between the detent gear 24 and the worm 34 can be suppressed from reducing, rattling due to backlash between the detent gear 24 and the worm 34 can be suppressed, enabling rattling (pivoting) of the lever 14 to be suppressed.

Moreover, a lower (downward) end of the detent gear 24 is meshed with the worm 34. This enables the weight of the detent gear 24 itself to act effectively at the meshed position between the detent gear 24 and the worm 34, enabling rattling due to backlash between the detent gear 24 and the worm 34 to be suppressed further, and enabling rattling (pivoting) of the lever 14 to be suppressed further.

The detent gear 24 is fitted together with (arranged at) an outer periphery of the rotation shaft 14A of the lever 14. This means that rattling of the lever 14 with respect to the detent gear 24 can be suppressed, and rattling (pivoting) of the lever 14 can be suppressed further.

Furthermore, the worm 34 is not able to move forward with respect to the output shaft 32A of the motor 32, and the holder wall 36A of the holder 36 limits movement of the worm 34 toward the rear due to the urging force of the holder spring 40. This thereby enables rattling (rotation) of the detent gear 24 due to rattling (movement) of the worm 34 in the front-rear direction to be suppressed, enables rattling (rotation) of the rotation shaft 14A (containing the detent pin 26) of the lever 14 to be suppressed further, enabling rattling (pivoting) of the lever 14 to be suppressed further.

Moreover, there is a single detent pin 26 provide to the detent mechanism 22, and the detent mechanism 22 urges the detent gear 24 at a single location. This enables a simple configuration of the detent mechanism 22.

Note that in the present exemplary embodiment the detent mechanism 22 urges the detent gear 24 at a single location. However, the detent mechanism 22 may urge the detent gear 24 at plural locations. In such cases, it is sufficient for a combined force of urging forces of the detent mechanism 22 toward the plural locations of the detent gear 24 to be directed toward the side of the meshed position between the detent gear 24 and the worm 34 at all shift positions of the lever 14.

Moreover, in the detent mechanism 22 of the present exemplary embodiment, elastic force of the detent spring 28 urges the detent gear 24 toward the lower side with respect to the rotation shaft 14A (containing the detent pin 26) of the lever 14, and the lever 14 is urged toward the shift position side. However, in the detent mechanism 22, a magnet provided to at least one of the rotation shaft 14A of the lever 14 and the detent gear 24 may urge the detent gear 24 by magnetic force toward the lower side with respect to the rotation shaft 14A such that the lever 14 is urged toward the shift position side.

In such cases, for example, by providing a first magnet to a lower side portion of the rotation shaft 14A and providing plural second magnets to a lower side portion of the detent gear 24, the detent gear 24 may be urged toward the lower side with respect to the rotation shaft 14A by repulsion (magnetic force) between the first magnet and the plural second magnets, and the lever 14 may be urged toward the shift position side. Moreover, for example, by providing a first magnet to an upper side portion of the rotation shaft 14A and providing plural second magnets to an upper side portion of the detent gear 24, the detent gear 24 may be urged toward the lower side with respect to the rotation shaft 14A by attraction (magnetic force) between the first magnet and the plural second magnets, and the lever 14 may be urged toward the shift position side (one of the first magnet or the second magnets may be metal).

### Second Exemplary Embodiment

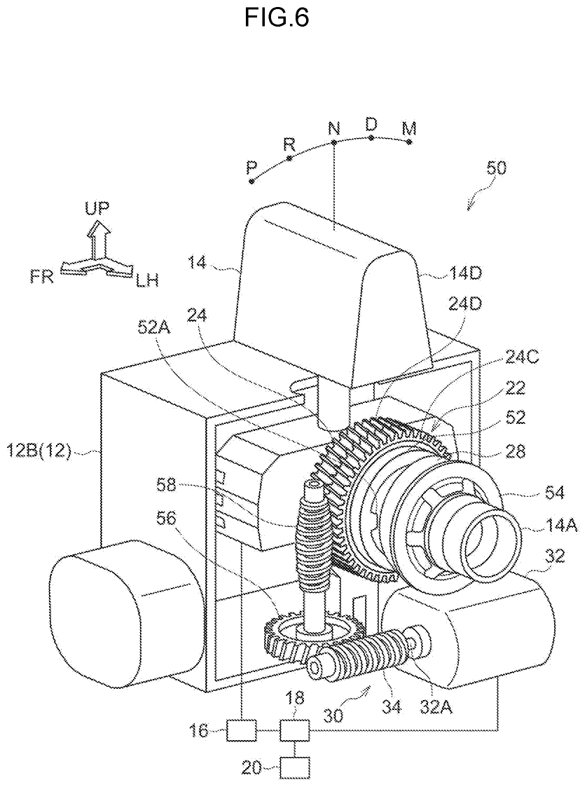

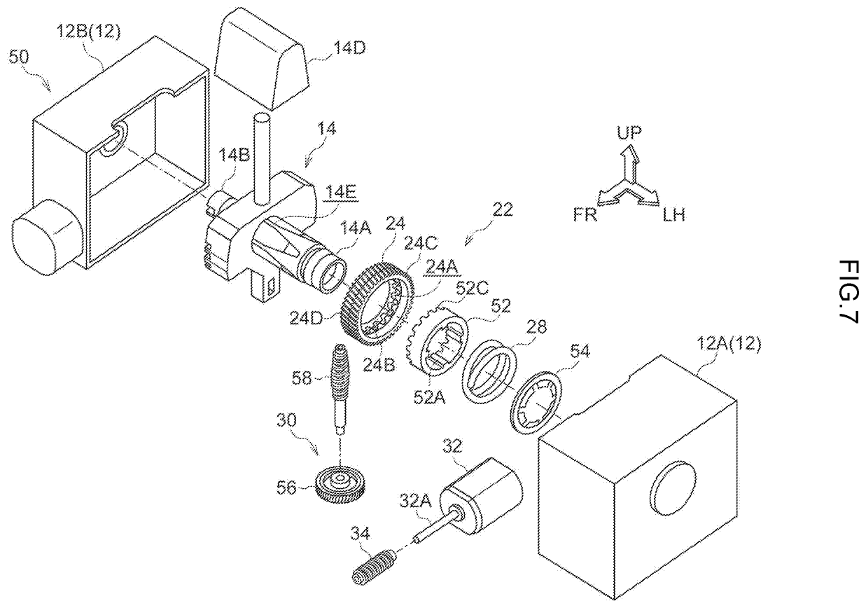

FIG. 6 illustrates a perspective view of a shift device 50 according to a second exemplary embodiment, as viewed obliquely from the left front, and FIG. 7 illustrates an exploded perspective view of the shift device 50 as viewed obliquely from the left front.

The shift device 50 according to the present exemplary embodiment is configured substantially similarly to that of the first exemplary embodiment, however differs therefrom in the following respects.

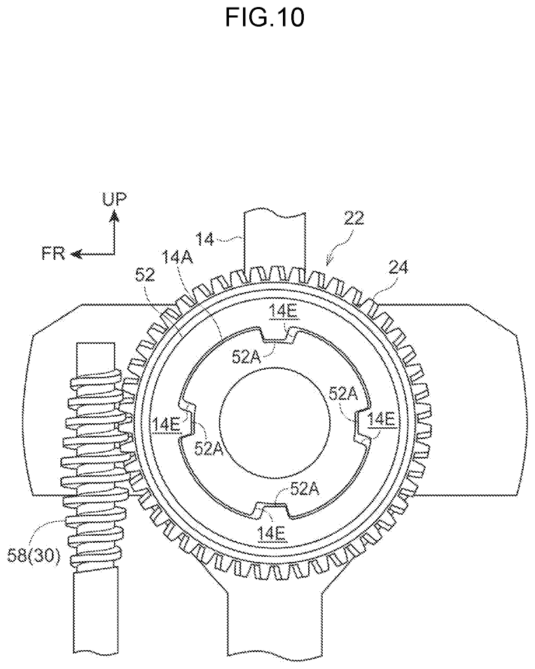

As illustrated in FIG. 7, in the shift device 50 according to the present exemplary embodiment, plural (four in the present exemplary embodiment) rectangular plate shaped insertion grooves 14E (see FIG. 10) are formed in a right end portion (base end portion) of an outer peripheral surface of the rotation shaft 14A of the lever 14, with the plural insertion grooves 14E being disposed at a uniform spacing along the circumferential direction of the rotation shaft 14A and each being open toward the left side.

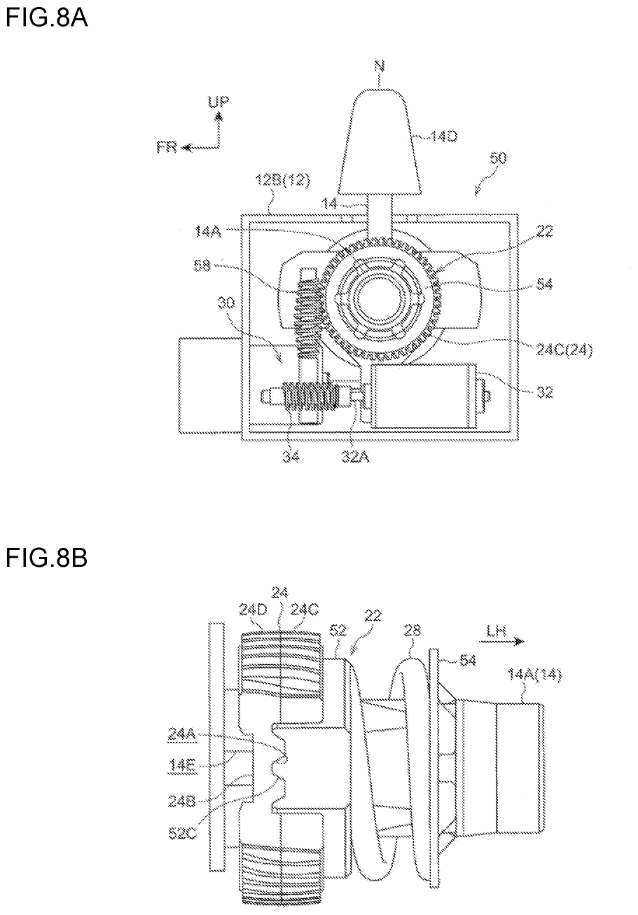

In the detent mechanism 22, a substantially circular cylinder shaped detent wall 24B is integrally formed at a right end portion of an inner peripheral surface of the detent gear 24, and the detent wall 24B is disposed coaxially to the detent gear 24. The rotation shaft 14A of the lever 14 is coaxially fitted inside the detent wall 24B, and the detent gear 24 is configured so as to be able to rotate about a center axis of the rotation shaft 14A and to be restricted from rotating as described later. Plural recesses 24A (see FIG. 8B) having substantially trapezoidal shaped in cross-sections are formed to a left surface of the detent wall 24B, and the recesses 24A extend along radial directions of the detent gear 24. The plural recesses 24A are arranged a uniform spacing along the circumferential direction of the detent gear 24, and the arrangement spacing angle of the recesses 24A is the same as the pivoting angle between each of the shift positions of the lever 14.

As illustrated in FIG. 6 and FIG. 7, the detent gear 24 is divided into a left gear 24C on the left side and a right gear 24D on the right side, with relative movement of the left gear 24C and the right gear 24D restricted in both the axial direction and radial directions. The left gear 24C and the right gear 24D are relatively urged in opposite directions of the circumferential direction to each other, with the detent gear 24 being configured into a so-called scissor gear.

A substantially circular cylinder shaped detent tube 52 that is made of resin and serves as a urging member is provided at the left side of the detent gear 24, with the rotation shaft 14A of the lever 14 passing through and coaxially fitting inside the detent tube 52, and the detent tube 52 coaxially fitting inside the detent gear 24.

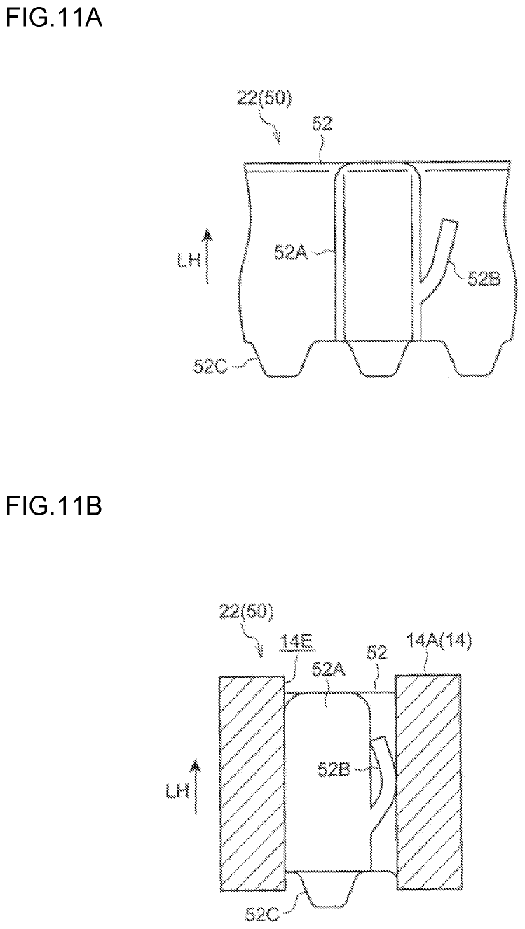

Plural (four in the present exemplary embodiment) rectangular plate shaped insertion plates 52A (see FIG. 11A) are integrally formed at an inner peripheral surface of the detent tube 52, with the plural insertion plates 52A disposed at a uniform spacing along the circumferential direction of the detent tube 52. Urging pawls 52B are integrally formed at a right portion of one side surface of the insertion plates 52A, with the urging pawls 52B each extending in a direction toward the one side of the insertion plate 52A in accordance with progression toward the left. The insertion plates 52A and the urging pawls 52B are inserted inside the respective insertion grooves 14E of the rotation shaft 14A of the lever 14 (see FIG. 11B), the urging pawls 52B are elastically bent toward the insertion plate 52A side, the insertion plates 52A and the urging pawls 52B are fitted together with the inside of the insertion grooves 14E in the circumferential direction of the detent tube 52, with a leading end (left end) of each of the urging pawls 52B abutting against the one side surface of the insertion plates 52A. This enables the detent tube 52 to rotate integrally with the rotation shaft 14A, and to move in the left-right direction with respect to the rotation shaft 14A.

Plural projections 52C (see FIG. 8B) having substantially trapezoidal shaped in cross-sections are integrally formed at a right end surface of the detent tube 52, with the projections 52C extending along radial directions of the detent tube 52. The plural projections 52C are arranged a uniform spacing along the circumferential direction of the detent tube 52, with the arrangement spacing angle of the projections 52C being the same as the pivoting angle between each of the shift positions of the lever 14.

A detent spring 28 is provided at a left side of the detent tube 52, with the rotation shaft 14A of the lever 14 passing coaxially through inside the detent spring 28. A substantially circular ring plate shaped push nut 54 is provided at a left side of the detent spring 28, with the push nut 54 fixed coaxially together with the rotation shaft 14A. The detent spring 28 spans between the push nut 54 and the detent tube 52, with the detent spring 28 urging the detent tube 52 toward the right side.

When the lever 14 is being positioned in each of the shift positions, the projections 52C of the detent tube 52 are inserted into the recesses 24A of the detent gear 24 by the urging force of the detent spring 28, and fit together with the recesses 24A in the circumferential direction of the detent gear 24 (see FIG. 8A and FIG. 8B). This means that the rotational position of the rotation shaft 14A is maintained, and the lever 14 is held in each of the shift positions (is urged toward each shift position side).

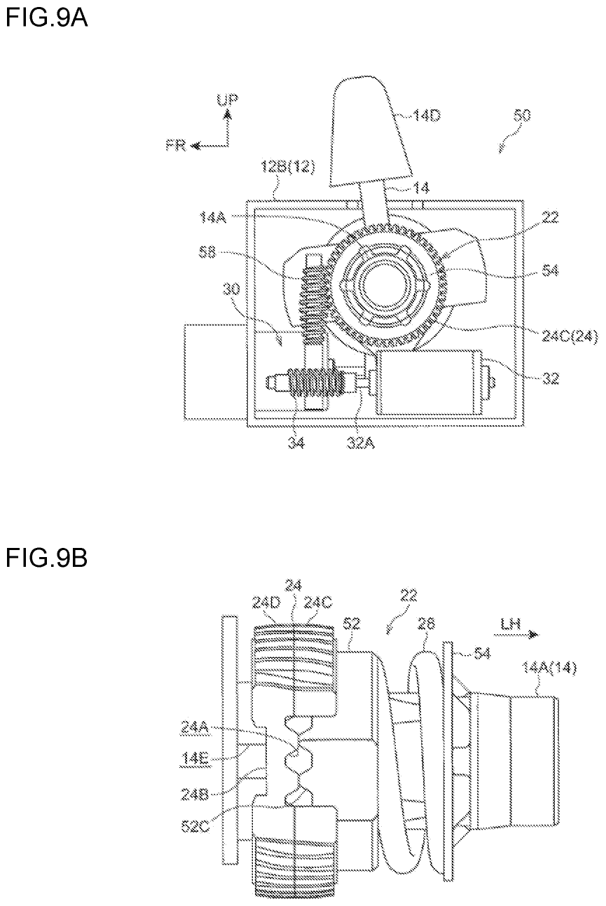

When the lever 14 is pivotally operated to change the shift position of the lever 14, the rotation shaft 14A is rotated, and the detent tube 52 is rotated (see FIG. 9A and FIG. 9B). This means that after the projections 52C have exited from the recesses 24A while the detent tube 52 is moved toward the left side against the urging force of the detent spring 28, the projections 52C are then inserted into the recesses 24 adjacent to these recesses 24A while the detent tube 52 is moved toward the right side by the urging force of the detent spring 28. This means that after a pivot resistance force has acted in the pivot-operation of the lever 14, a pivoting assist force then acts, with a ratcheting sensation acting on the pivot-operation of the lever 14. [0063] In the drive mechanism 30, the motor 32 is fixed inside the left plate 12A at a lower side of the detent mechanism 22. The output shaft 32A of the motor 32 extends forward, and the worm 34 is not able to move in the front-rear direction with respect to the output shaft 32A.

A helical gear 56 (worm wheel) is provided at the right side of the worm 34, with the worm 34 meshed with a left end of the helical gear 56. The worm 34 restricts rotation of the helical gear 56, and the helical gear 56 is rotated when the worm 34 is rotated.

The helical gear 56 is coaxially fixed to a lower portion of a worm shaft 58 (worm), and the helical gear 56 and the worm shaft 58 are configured so as to be unable to move relatively in the up-down direction (axial direction). The helical gear 56 and the worm shaft 58 are not able to rotate relatively, and the worm shaft 58 rotates integrally with the helical gear 56. The helical gear 56 and the worm shaft 58 are supported so as to be rotatable and movable in the up-down direction inside the left plate 12A, and when the helical gear 56 and the worm shaft 58 are urged downward, movement downward is also restricted.

The worm shaft 58 meshes with a front end of the detent gear 24 of the detent mechanism 22, with teeth of the worm shaft 58 nipped between teeth of the left gear 24C and teeth of the right gear 24D by relative urging force of the left gear 24C and the right gear 24D of the detent gear 24. The worm shaft 58 restricts rotation of the detent gear 24, and the detent gear 24 is rotated when the worm shaft 58 is rotated.

Next, description follows regarding operation of the present exemplary embodiment.

In the shift device 50 configured as described above, the detent gear 24 of the detent mechanism 22 and the worm shaft 58 of the drive mechanism 30 are meshed together, causing the worm shaft 58 to restrict rotation of the detent gear 24.

When the lever 14 is pivotally operated to change the shift position of the lever 14, in the detent mechanism 22, after the projections 52C of the detent tube 52 have exited from the recesses 24A of the detent gear 24 against the urging force of the detent spring 28, the projections 52C are inserted into the recesses 24A adjacent to these recesses 24A by the urging force of the detent spring 28.

When the shift position of the lever 14 has been changed (when the detection device 16 has detected a change in the shift position of the lever 14), a shift range of the automatic transmission mechanism 20 is changed under control from the control device 18 to the shift range corresponding to the shift position of the lever 14.

Moreover when, for example, the vehicle is driving autonomously (including parking autonomously), the shift range of the automatic transmission mechanism 20 is changed automatically under control from the control device 18. In cases in which the shift range of the automatic transmission mechanism 20 has been changed automatically, the motor 32 is driven in the drive mechanism 30 under control from the control device 18 based on the shift position of the lever 14 as detected by the detection device 16. This means that the worm 34, the helical gear 56, the worm shaft 58, the detent gear 24, the detent tube 52, and the rotation shaft 14A of the lever 14 are rotated to pivot the lever 14, thereby, the shift position of the lever 14 is changed and the shift position of the lever 14 corresponds to the shift range of the automatic transmission mechanism 20.[0072] This means that the shift position of the lever 14 is changed even though the projections 52C of the detent tube 52 do not exit from the recesses 24A of the detent gear 24 against the urging force of the detent spring 28, and so a rotation load on the detent gear 24 from the motor 32 is lessened, and the time taken to change the shift position of the lever 14 is shortened. Furthermore, noise from the projections 52C being inserted into the recesses 24A by the urging force of the detent spring 28 is limited from occurring, lessoning operation noise. Moreover, pivoting of the lever 14 becomes smoothly due to the projections 52C not coming out from the recess 24A against the urging force of the detent spring 28 nor being inserted therein by the urging force of the detent spring 28.

When the motor 32 is driven and the lever 14 is being pivoted, the projections 52C of the detent tube 52 exit from the recesses 24A of the detent gear 24 against the urging force of the detent spring 28 if pivoting of the lever 14 is limited, allowing the detent tube 52 and the rotation shaft 14A of the lever 14 to rotate with respect to the detent gear 24. This means that damage to the detent gear 24 or the worm shaft 58 is suppressed from occurring.

The teeth of the worm shaft 58 are nipped between teeth of the left gear 24C and teeth of the right gear 24D by the relative urging force of the left gear 24C and the right gear 24D of the detent gear 24. Therefore, rattling due to backlash between the detent gear 24 and the worm shaft 58 can be suppressed, enabling rattling (rotation) of the detent gear 24 with respect to the worm shaft 58 to be suppressed, and rattling (rotation) of the detent tube 52 and the rotation shaft 14A of the lever 14 can be suppressed, enabling rattling (pivoting) of the lever 14 to be suppressed. This accordingly enables the pivot-operation performance of the lever 14 to be improved, and also enables the shift range change performance of the automatic transmission mechanism 20 using the pivot-operation of the lever 14 to be improved.

Furthermore, due to the insertion plates 52A and the urging pawls 52B of the detent tube 52 being inserted inside the insertion grooves 14E of the rotation shaft 14A, the urging pawls 52B are elastically bent toward the insertion plate 52A side, and the insertion plates 52A and the urging pawls 52B are fitted together with the inside of the insertion grooves 14E in the circumferential direction of the detent tube 52. This thereby enables rattling (rotation) of the rotation shaft 14A with respect to the detent tube 52 to be suppressed, enabling rattling (pivoting) of the lever 14 to be suppressed further.

Moreover, the helical gear 56 is urged downward and downward movement is restricted. This accordingly enables rattling due to backlash between the helical gear 56 and the worm 34 to be suppressed, rattling (rotation) of the helical gear 56 with respect to the worm 34 to be suppressed, rattling (rotation) of the worm shaft 58, the detent gear 24, the detent tube 52, and the rotation shaft 14A of the lever 14 to be suppressed, and rattling (pivoting) of the lever 14 to be suppressed further.

### Modified Example

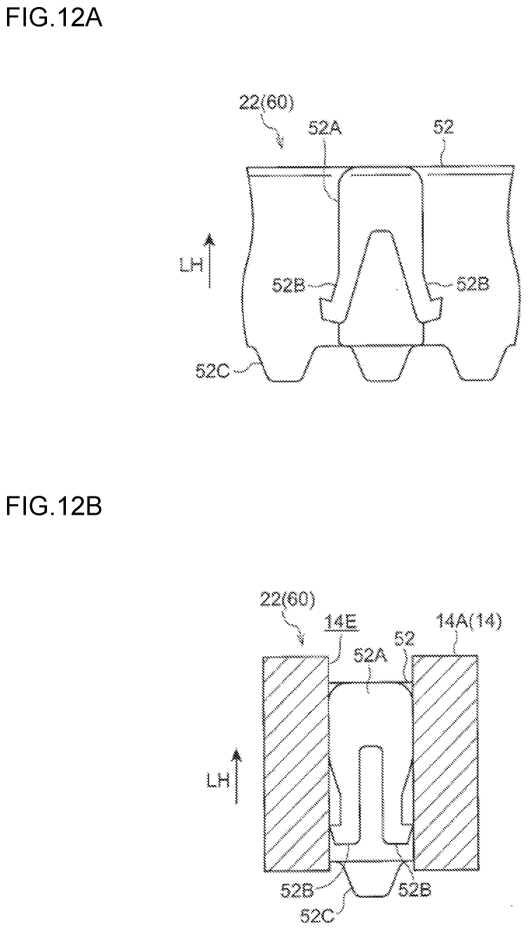

FIG. 12A illustrates a side view of a detent tube 52 of a shift device 60 according to a modified example of the second exemplary embodiment.

As illustrated in FIG. 12A, in the shift device 60 according to the present modified example, in a detent mechanism 22, at a right side portion of an insertion plate 52A of the detent tube 52, an elongated plate shaped urging pawl 52B is formed at both side of the circumferential direction of detent tube 52, with the urging pawls 52B extending in a direction toward one side of the insertion plate 52A in accordance with progression toward the right, and leading end portions thereof also protruding in a direction toward a side direction outside of the insertion plate 52A. The insertion plate 52A and a pair of the urging pawls 52B are inserted inside the insertion groove 14E of the rotation shaft 14A of the lever 14 (see FIG. 12B), the pair urging pawls 52B are elastically bent toward the insertion plate 52A side, and the insertion plate 52A is substantially fitted together with the inside of the insertion groove 14E in the circumferential direction of the detent tube 52, with leading ends of the pair of urging pawls 52B respectively abutting against the two side surfaces of the insertion groove 14E. This enables the detent tube 52 to rotate integrally with the rotation shaft 14A and to move in the left-right direction with respect to the rotation shaft 14A.

In the modified example, similar operation and advantageous effects to those of the second exemplary embodiment can be achieved.

Note that in the first exemplary embodiment and the second exemplary embodiment (including the modified example), the lever 14 (shift body) is pivoted. However, the shift body may be slid or may be rotated about a center axis line.

Furthermore, in the first exemplary embodiment and the second exemplary embodiment (including the modified example), the shift devices 10, 50, 60 are installed to a consol. However, the shift devices 10, 50, 60 may be installed to an instrument panel or to a steering column.

The entire content of the disclosure of Japanese Patent Application No. 2020-197526 filed on Nov. 27, 2020 is incorporated by reference in the present specification.

### EXPLANATION OF REFERENCE NUMERALS

10 . . . shift device, 14 . . . lever (shift body), 22 . . . detent mechanism (urging mechanism), 24 . . . detent gear (connecting member), 30 . . . drive mechanism (moving mechanism)

1. A shift device, comprising:
a shift body that is movable to change a shift position;
an urging mechanism provided with a connecting member, the urging mechanism being configured to urge the connecting member such that the shift body is urged toward a shift position side; and
a moving mechanism connected to the connecting member, the moving mechanism being configured to move the shift body via the urging mechanism, with the urging mechanism urging the connecting member toward a side of a connecting position between the moving mechanism and the connecting member at all shift positions of the shift body.

2. The shift device of claim 1, wherein the urging mechanism urges the connecting member toward the connecting position between the connecting member and the moving mechanism at a center position of all shift positions of the shift body.

3. The shift device of claim 1, wherein a lower side of the connecting member is connected to the moving mechanism.

4. The shift device of claim 1, wherein the urging mechanism urges the connecting member at a single location.

5. The shift device of claim 1, wherein the shift body is rotatable and the connecting member is disposed on a rotation shaft of the shift body.

6. The shift device of claim 5, wherein the connecting member is fitted to the rotation shaft of the shift body.

7. The shift device of claim 5, further comprising an urging member that is provided to the urging mechanism, that is disposed at the rotation shaft of the shift body and that urges the connecting member such that the shift body is urged toward a shift position side.

8. The shift device of claim 1, further comprising a connected member that is provided to the moving mechanism, connected to the connecting member, and urged.

9. The shift device of claim 1, wherein the urging mechanism urges the connecting member using magnetic force.
